(19) United States
(12) Patent Application Publication
(10) Pub. No.: US 2007/0168664 A1
(43) Pub. Date: Jul. 19, 2007

(54) Data encryption/decryption for data storage drives

(76) Inventors: Brian Gerard Goodman, Tucson, AZ (US); Glen Alan Jaquette, Tucson, AZ (US); Leonard George Jesionowski, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/329,002

(22) Filed: Jan. 10, 2006

(51) Int. Cl. H04L 9/00

(52) U.S. Cl. 713/171

(57) ABSTRACT

A key server provides keys for encryption and/or decryption for data storage drives. A first communication link provides at least data communication with respect to the data storage drive; a second communication link, separate from the first communication link, provides communication between the data storage drive and the key server; and the key server provides the encryption and/or decryption keys over the second communication link.

### FIELD OF THE INVENTION

This invention relates to data storage drives, such as magnetic tape data storage drives, and, more particularly, to data encryption/decryption of the data stored by the data storage drives.

### BACKGROUND OF THE INVENTION

It is desirable that data stored by data storage drives, especially data stored on removable media, such as data stored on magnetic tape cartridges by magnetic tape data storage drives, be encrypted. The encryption of the data on data storage media may be conducted by a host system or user before the data is sent to the data storage drive, and the keys maintained by the host system and the user interacts with the host application to define and use the keys. However, not all host applications support encryption, and software based encryption consumes a lot of processor bandwidth. Alternatively, the encryption may be conducted by a processor between the host system and the drive, called a “bump in the wire”. The user interacts with the processor to define and use the keys. This approach is expensive as requiring a processor or device for each port. Another approach is for the drive itself to provide the data encryption, for example in hardware and/or firmware, and maintain the keys. The drive does not have a convenient means for providing a user interface, and having the key maintenance and the encryption together poses a risk that a drive could be removed and the keys and encryption could be reverse engineered. Making data storage drives tamper proof would be very expensive.

### SUMMARY OF THE INVENTION

Systems, automated data storage libraries and methods are provided for providing keys for encryption and/or decryption for data storage drives which are configured to provide encryption and/or decryption.

In one embodiment, a first communication link is configured to provide at least data communication with respect to the data storage drive; a second communication link, separate from the first communication link, is configured to provide communication between the data storage drive; and a key server is configured to provide encryption and/or decryption keys to the data storage drive via the second communication link.

In a further embodiment, the key server is configured to respond to requests for the encryption keys, and to provide the keys based on the requests.

In another embodiment, the data storage drive provides the requests.

In a further embodiment, the second communication link comprises a control configured to respond to key requests from the data storage drive, to send key requests to the key server, and to send the provided encryption and/or decryption keys to the data storage drive.

In another embodiment, the second communication link control adds source and/or destination routing information to send the key requests to the key server, and uses the routing information to send the provided encryption and/or decryption keys to the data storage drive.

In another embodiment, the second communication link control comprises a control of an automated data storage library.

For a fuller understanding of the present invention, reference should be made to the following detailed description taken in conjunction with the accompanying drawings.

### BRIEF DESCRIPTION OF THE DRAWINGS

FIG. 1 is an isometric illustration of an automated data storage library which may implement the present invention;

FIG. 2 is an illustration view of an opened frame of the automated data storage library of FIG. 1;

FIG. 3 is a block diagram of an embodiment of an encryption/decryption system in accordance with the present invention; and

FIG. 4 is a flow chart depicting embodiments of methods in accordance with the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

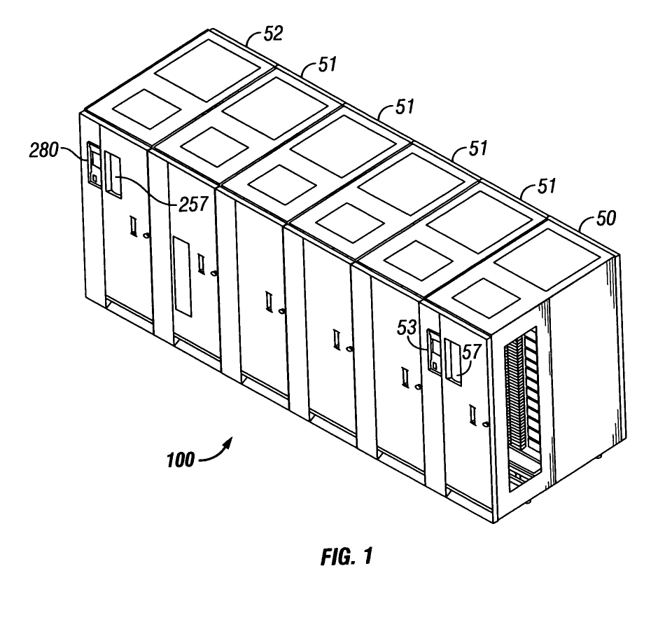

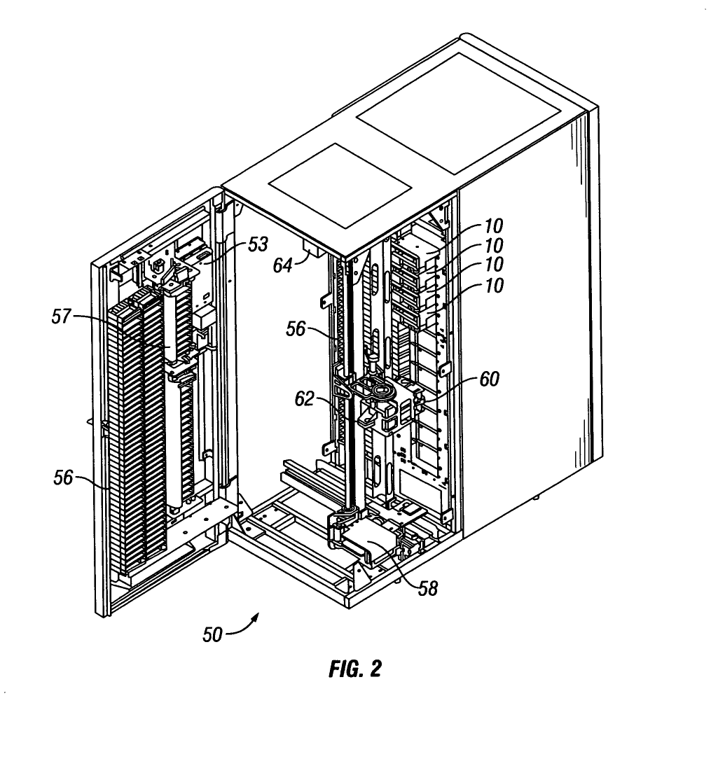

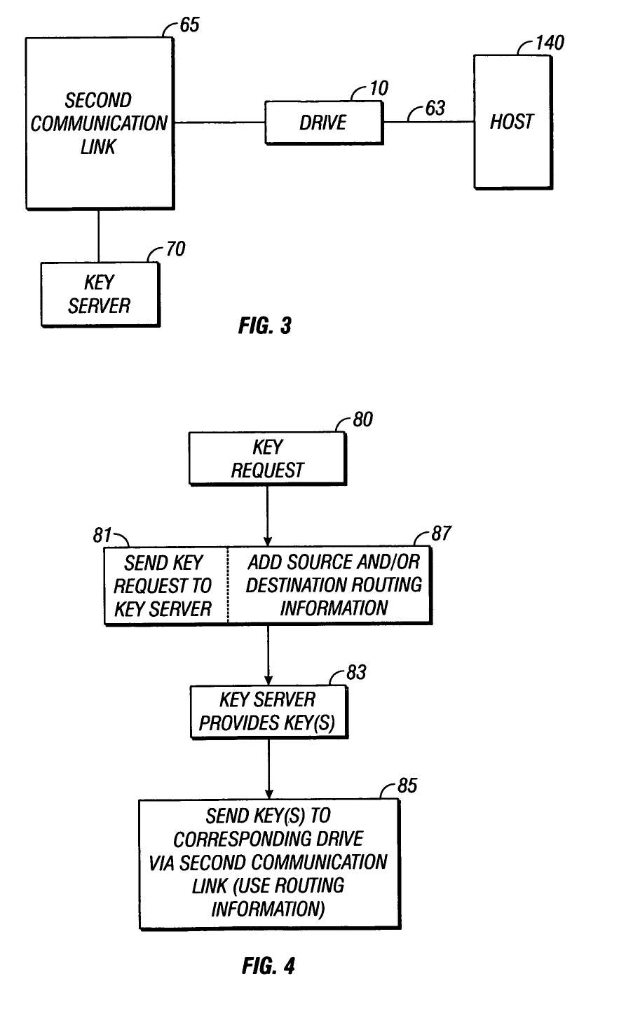

FIG. 3 illustrates an embodiment of the present invention which may be implemented with respect to an automated data storage library 100 as depicted in FIGS. 1 and 2. The automated data storage library 100 is arranged to access data storage cartridges, such as magnetic tape cartridges, typically in response to commands from at least one external host system 140, and comprises one or more frames 50, 51, 52, each of which may have a plurality of storage shelves 56 for storing the cartridges, and comprises one or more data storage drives 10 for reading and/or writing data with respect to the data storage cartridges. The library 100 further comprises at least one robot accessor 58 for transporting the cartridges between the storage shelves 56 and the data storage drives 10. The robot accessor 58 comprises a gripper assembly 60 for gripping one or more cartridges, and comprises a sensor 62, such as an LED (Light Emitting Diode) emitter/detector, a bar code scanner, RFID reader, or other reading system to read the identifiers or labels of the cartridges or about the library.

Still referring to FIGS. 1, 2 and 3, the library 100 also comprises one or more library controllers 64 to operate the library, communicate with a host system 140 or host systems, communicate with the data storage drive(s) 10, and to communicate with other processors of the library (if present). Alternatively, the data storage drives 10 may communicate with a host system or systems 140 directly, and/or the library to host system or systems communication may be through the drive communication for example, as described in U.S. Pat. No. 6,434,090. The communication with the data storage drives 10 typically comprises communication of data and commands;

This communication link is depicted in FIG. 3 as a first communication link 63 configured to provide at least data communication with respect to the data storage drive 10. Further, referring to FIGS. 1, 2 and 3, the library may provide one or more operator panels 53, 280, or other user interface such as a web user interface, for communicating with the library controller. The library controller may be set up as a centralized control system, or as a distributed control system. In the example of a distributed control system, additional processors may together with processor 64 comprise the library controller, and operate specific functions of the library, such as to operate the robot accessor 58 to transport the data storage cartridges, to control the operator panels 53, 280, or other user interface, and to provide communications to host computers, remote computers, and to the data storage drives, etc. An example of a distributed control system incorporated in an automated data storage library is described in U.S. Pat. No. 6,356,803. An example of an automated data storage library comprises the IBM® 3584 tape library.

The library controller(s) 64 typically comprises logic and/or one or more microprocessors with memory for storing information and program information for operating the microprocessor(s). Herein “processor” may comprise any suitable logic, microprocessor, and associated memory for responding to program instructions, and the associated memory may comprise fixed or rewritable memory or data storage devices. The program information may be supplied to the library controller or memory from a host 140 or via a data storage drive 10, or by an input from a floppy or optical disk, or by being read from a cartridge, or by a web user interface or other network connection, or by any other suitable means.

Data storage cartridges are stored in the storage shelves 56 and may be added to or removed from the library, for example, at input/output stations 57, 257. As is understood by those of skill in the art, data storage cartridges may comprise magnetic or optical tape cartridges, magnetic or optical disc cartridges, electronic media cartridges such as PROM (Programmable Read Only Memory), EEPROM (Electrically Erasable Programmable Read Only Memory), flash PROM, MRAM (Magnetoresistive Random Access Memory), Compactflash™, Smartmedia™, Memory Stick™, etc, or other media. A magnetic tape data storage cartridge comprises a length of magnetic tape wound on one or two reels, an example of which is those adhering to the Linear Tape Open (LTO) format. One example of a magnetic tape data storage drive 10 is the IBM® 3580 Ultrium magnetic tape drive based on LTO technology. A further example of a single reel magnetic tape data storage drive and associated cartridge is the IBM® 3592 TotalStorage Enterprise magnetic tape drive and associated magnetic tape cartridge. An example of a dual reel cartridge is the IBM® 3570 magnetic tape cartridge and associated drive.

The data storage drive 10 is configured to provide encryption and/or decryption, for example, by means of hardware or firmware.

In accordance with the present invention, a key server 70 is configured to respond to requests for encryption and/or decryption keys, providing the encryption and/or decryption keys, and may perform additional key management functions, and a second communication link 65 is configured to provide communication between the data storage drive 10 and the key server 70. The requests for encryption and/or decryption keys may comprise a direct request. For example, a data storage drive 10 may determine that it needs a key to read and/or write media and it may request one or more keys. Alternatively, the request may comprise an indirect or implied request. For example, upon power-up or reset, the data storage drive 10 may initiate communication with the key server 70 and this may cause the key server to provide the drive with one or more keys. In one variation of this example, the drive may hold the keys in volatile memory and there may not be a need to request keys as long as the volatile memory is intact. In another example, the second communication link 65 may perform the request on behalf of the drive. In one variation of this example, the second communication link may comprise an automated data storage library 100, 50 and upon loading media into the data storage drive 10, or upon receiving a request to load media into the data storage drive 10, the library may request one or more keys for the data storage drive 10. Still further, the key server 70 may provide keys to the data storage drive 10 without a request. For example, the key server 70 may initiate the communication to/from the data storage drive 10. In one variation of this example, a request for encryption and/or decryption keys may be direct, indirect, or implied, or may be initiated by the key server or the second communication link.

The second communication link may comprise the library controller 64 to process and forward the key requests and keys as will be discussed.

The first communication link 63, or the second communication link 65 may comprise a network, a point-to-point system, or a combination. If a network, the first communication link 63 and the second communication link 65 may comprise different paths of the same network. For example, first communication link 63, or the second communication link 65 may comprise serial interfaces such as RS-232 (Recommended Standard), RS-422, CAN (Controller Area Network), USB (Universal Serial Bus), SAS (Serial Attached SCSI, IEEE 1394 (Institute of Electrical and Electronics Engineers), Ethernet, Fibre Channel, or any other serial interface as is known to those of skill in the art. Alternatively, the first communication link 63, or the second communication link 65 may comprise optical interfaces such as Fibre Channel, ESCON (Enterprise Systems CONnection), or any other optical interface as is known to those of skill in the art. In addition, the first communication link 63, or the second communication link 65 may comprise wireless interfaces such as IEEE 802.11, RF infrared, laser, or any other wireless interface as is known to those of skill in the art. Still further, the first communication link 63, or the second communication link 65 may comprise parallel interfaces such as SCSI (Small Computer Systems Interface), IEEE 1284, or any other parallel interface as is known to those of skill in the art.

In accordance with the present invention, the second communication link 65 is separate from the first communication link 63. In addition, the second communication link 65 may comprise more than one communication interface. For example, the second communication link 65 may comprise redundant communication interfaces between the data storage drive 10 and a key server 70. In another example where the second communication link comprises elements of an automated data storage library, the data storage drive 10 may be coupled to a library with one communication interface and the library may be coupled to a key server 70 with another communication interface. In yet another example, the data storage drive 10 may be coupled to a key server 70 through a network of different communication interfaces.

The encryption and/or decryption comprise any suitable algorithms and ciphers, and the accompanying keys and/or passwords. Examples include the “Advanced Encryption Standard”, “Symmetric Key Algorithms”, and “Public Key Encryption”, of various types, as is known to those of skill in the art. The key server 70 may be configured to respond to requests for encryption and/or decryption keys, providing the encryption and/or decryption keys, and may perform additional key management functions, such as allowing certain users to distribute and/or revoke keys with respect to themselves or other users or with respect to certain data or data types.

The key server 70 may comprise a dedicated server or controller, a host computer, the library controller 64 or a portion of the library controller, a storage controller, or a controller integrated into a switch, hub, or router, etc.

In one embodiment, the data storage drive 10 communicates directly with the key server 70, such that the second communication link 65 comprises that direct communication capability.

Alternatively, the library, for example, library controller 64, may comprise a portion of the second communication link 65, providing a communication bridge between the data storage drive and the key server. If the library controller is involved in the host communication path 63, that path is separate from the second communication link 65, for example, operating with a second interface of the data storage drive than the data handling, or host, interface.

Referring additionally to FIG. 4, in step 80, the data storage drive 10, in order to encrypt and/or decrypt data, sends a key request over the second communication link 65. In one embodiment, the request is sent directly to the key server. Optionally, for example where the second communication link comprises a control, such as controller 64, the control, in step 81, responds to key requests from the data storage drive, and sends key requests to the key server 70.

In step 83, the key server 70 provides the key(s) and, in step 85, sends the provided encryption and/or decryption keys to the data storage drive. Optionally, where the second communication link comprises a control, the control forwards the key(s) to the data storage drive 10. The data storage drive provides the actual data encryption and/or decryption using the key(s) supplied by the key server, as is known to those of skill in the art.

In another embodiment, the second communication link control, in step 87, adds source and/or destination routing information to send the key requests to the key server, and, in step 85, uses the routing information to forward the provided encryption and/or decryption keys to the data storage drive. In the environment of a number of data storage drives, the routing information will ensure that the desired key(s) are provided to the correct data storage drive. The source information may be used to tell which drive the request came from and/or which drive to send the encryption and/or decryption keys to. The destination information may be used to tell where a key request should be sent to. For example, an IP address of a key server. In addition, there may be more than one key server. For example, a primary key server and a backup key server. Additionally, the routing information may implement the protocol for the network. For example, the TCP/IP protocol provides different layers with different levels or types of routing such as Ethernet MAC (Media Access Control) addresses, DLC (Data Link Control) addresses, IP (Internet Protocol) addresses, port numbers, etc.

The user may use a library interface, such as the operator panels 53, 280, or a web user interface of the library, or a library/host communication link, to set up the key server 70. This setup may involve routing information to tell the library where to forward the drive key requests, e.g. a TCP/IP address of the key server, etc. The user may be responsible for creating, importing, exporting, and deleting keys for data encryption. The key server 70 of FIG. 3 is preferably tamper proof such that an attempt to open the server to reverse engineer the keys will result in the keys being destroyed. The key server and/or the user would preferably provide means for backing up the keys.

Those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A system for providing keys for encryption and/or decryption for a data storage drive, said data storage drive configured to provide encryption and/or decryption, said system comprising:
a first communication link configured to provide at least data communication with respect to said data storage drive;
a second communication link, separate from said first communication link, configured to provide communication with respect to said data storage drive and said key server; and
a key server configured to provide encryption and/or decryption keys for said data storage drive via said second communication link.

2. The system of claim 1, wherein said key server is configured to respond to requests for said encryption and/or decryption keys, and wherein said key server provides said encryption and/or decryption keys based on said request.

3. The system of claim 2, wherein said second communication link comprises a control configured to respond to key requests from said data storage drive, to send key requests to said key server, and to send said provided encryption and/or decryption keys to said data storage drive.

4. The system of claim 3, wherein said second communication link control adds source and/or destination routing information to send said key requests to said key server, and uses said routing information to send said provided encryption and/or decryption keys to said data storage drive.

5. The system of claim 3, wherein said second communication link control comprises a control of an automated data storage library.

6. An automated data storage library, comprising:
a plurality of storage shelves configured to store data storage cartridges;
at least one robot accessor configured to transport said data storage cartridges;
at least one data storage drive configured to read and/or write data with respect to said data storage cartridges, said data storage drive configured to interface a first communication link configured to provide at least data communication with respect to said data storage drive, said data storage drive configured to provide encryption and/or decryption;
a second communication link, separate from said first communication link, configured to provide communication with respect to said at least one data storage drive; and
a key server configured to provide encryption and/or decryption keys to said at least one data storage drive via said second communication link.

7. The automated data storage library of claim 6, wherein said key server is configured to respond to requests for said encryption and/or decryption keys, and wherein said key server provides said encryption and/or decryption keys based on said request.

8. The automated data storage library of claim 7, wherein said at least one data storage drive is configured to request said encryption and/or decryption keys.

9. The automated data storage library of claim 8, wherein said at least one data storage drive is configured to provide said request via said second communication link.

10. The automated data storage library of claim 8, wherein said second communication link comprises library control configured to respond to key requests from said at least one data storage drive, to send key requests to said key server, and to send said provided encryption and/or decryption keys to said at least one data storage drive.

11. The automated data storage library of claim 7, wherein said second communication link comprises a control configured to add source and/or destination routing information to send said key requests to said key server, and uses said routing information to send said provided encryption and/or decryption keys to said at least one data storage drive.

12. A method for providing keys for encryption and/or decryption for a data storage drive, said data storage drive configured to interface a first communication link configured to provide at least data communication with respect to said data storage drive, said data storage drive configured to provide encryption and/or decryption, said method comprising the steps of:
a key server receiving at least one request for encryption and/or decryption keys;
said key server responding to said at least one request, providing said encryption and/or decryption keys via a second communication link separate from said first communication link, to said data storage drive.

13. The method of claim 12, wherein said steps of providing said at least one request, and of providing said encryption and/or decryption keys, each comprises providing said request and providing said encryption and/or decryption keys to a control, said control providing said request to said key server, and said control sending said provided encryption and/or decryption keys to said data storage drive.

14. The method of claim 13, wherein said data storage drive provides said at least one request via said second communication link.

15. The method of claim 13, wherein said step of providing said at least one request additionally comprises said control adding source and/or destination routing information to send said key requests to said key server; and said step of sending said provided encryption and/or decryption keys additionally comprises using said routing information to send said provided encryption and/or decryption keys to said data storage drive.

16. The method of claim 13, wherein said second communication link control comprises a control of an automated data storage library, and said data storage drive comprises a data storage drive of said automated data storage library.
